(19) United States
(12) Patent Application Publication
(10) Pub. No.: US 2015/0069744 A1
(43) Pub. Date: Mar. 12, 2015

(54) VEHICLE DEBRIS SHIELD

(71) Applicant: FRANKLIN D. ROBINSON, JR., Copperas Cove, TX (US)

(72) Inventor: FRANKLIN D. ROBINSON, JR., Copperas Cove, TX (US)

(21) Appl. No.: 14/231,135

(22) Filed: Mar. 31, 2014

Related U.S. Application Data
(60) Provisional application No. 61/875,444, filed on Sep. 9, 2013.

(51) Int. Cl. B60J 11/06

(52) U.S. Cl. CPC B60J 11/06
USPC 280/770

(57) ABSTRACT

Some embodiments of the present disclosure include a debris shield for preventing debris, like leaves, from entering an engine compartment of a vehicle, such as a car or truck. The debris shield may include a row comprising a plurality of panels, each panel being attached to an adjacent panel by a hinge. The row may be collapsible and expandable a proximal end a may have a proximal end, a distal end, and a bottom surface. The bottom surface of the row may be magnetic and, thus, may be configured to removably engage with a hood of the vehicle. The debris shield may also include a first loop attached to the proximal end of the row and a second loop attached to the distal end of the row, wherein the first and second loop are configured to attach to side mirrors on the vehicle, securing the debris shield in place.

### RELATED APPLICATION

This application claims priority to provisional patent application U.S. Ser. No. 61/875,444 filed on Sep. 9, 2013, the entire contents of which is herein incorporated by reference.

### BACKGROUND

The embodiments herein relate generally to vehicle accessories, and more particularly, to a shield for preventing debris from entering the engine compartment of a vehicle.

Debris, such as leaves, branches, and other materials, tend to fall on cars and trucks, accumulating on the vehicles. Particularly, debris tends to accumulate and build up in the exposed space between the bottom of a windshield and the beginning of the hood. This potentially results in unwanted debris infiltrating and clogging the engine compartment, intake and/or air conditioning systems. When debris clogs any of these areas, the elements of the car can be damaged, requiring costly repairs or replacements.

Therefore, what is needed is a removable shield that prevents debris from accumulating in the space between the windshield and the hood, thus preventing the debris from entering the engine compartment.

### SUMMARY

Some embodiments of the present disclosure include a debris shield for preventing debris from entering an engine compartment of a vehicle, such as a car or a truck. The debris shield may include a row comprising a plurality of panels, each panel being attached to an adjacent panel by a hinge. The row may be collapsible and expandable a proximal end a may have a proximal end, a distal end, and a bottom surface. The bottom surface of the row may be magnetic and, thus, may be configured to removably engage with a hood of the vehicle. The debris shield may also include a first loop attached to the proximal end of the row and a second loop attached to the distal end of the row, wherein the first loop and the second loop are configured to attach to side mirrors on the vehicle, securing the debris shield in place.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention shown in use.

FIG. 2 is a side detail view of one embodiment of the present invention shown in use.

FIG. 3 is a detail perspective view of one embodiment of the present invention shown in use.

FIG. 4 is a perspective view of one embodiment of the present invention.

FIG. 5 is a front view of one embodiment of the present invention, demonstrated in an unfolded state.

FIG. 6 is a front view of one embodiment of the present invention, demonstrated in a partially folded state.

FIG. 7 is a front view of one embodiment of the present invention, demonstrated in a folded state.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a debris shield for preventing debris, such as leaves, from entering the engine compartment of a vehicle, such as a car or a truck, and may comprise the following elements. This list of possible constituent elements is intended to be exemplary only, and it is not intended that this list be used to limit the system of the present application to just these elements. Persons having ordinary skill in the art relevant to the present disclosure may understand there to be equivalent elements that may be substituted within the present disclosure without changing the essential function or operation of the device.
1. Plurality of Panels
2. Plurality of Hinges
3. Mirror Fastener

The various elements of the debris shield of the present disclosure for preventing debris from infiltrating and clogging an engine compartment of a vehicle may be related in the following exemplary fashion. It is not intended to limit the scope or nature of the relationships between the various elements and the following examples are presented as illustrative examples only.

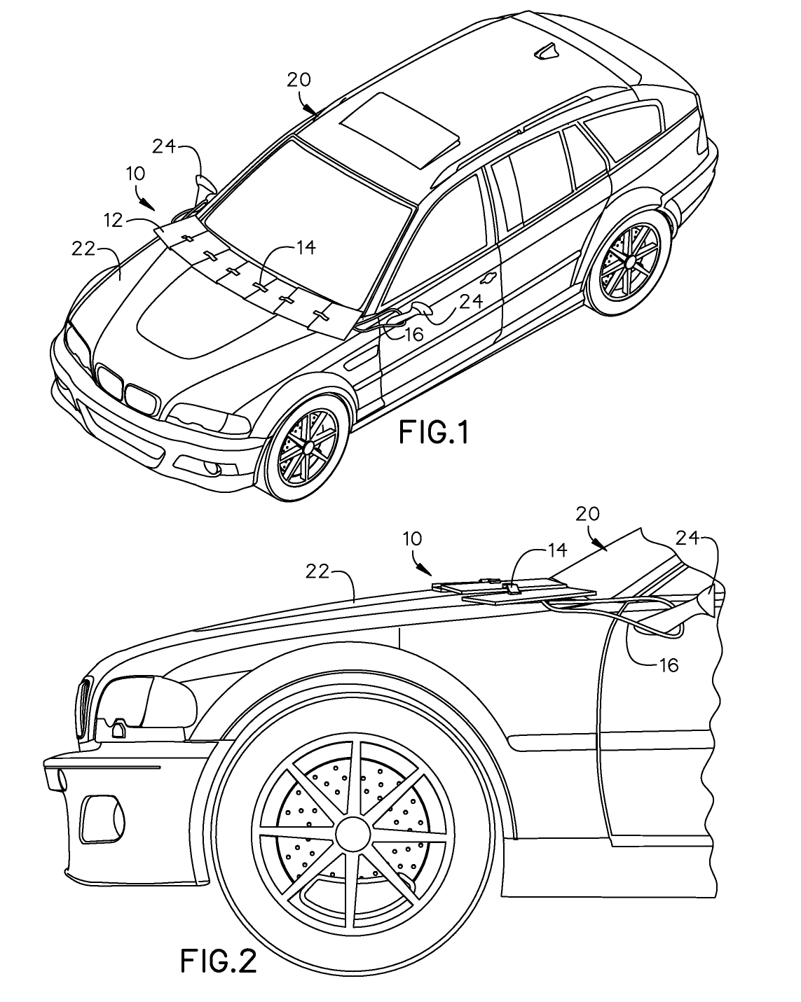

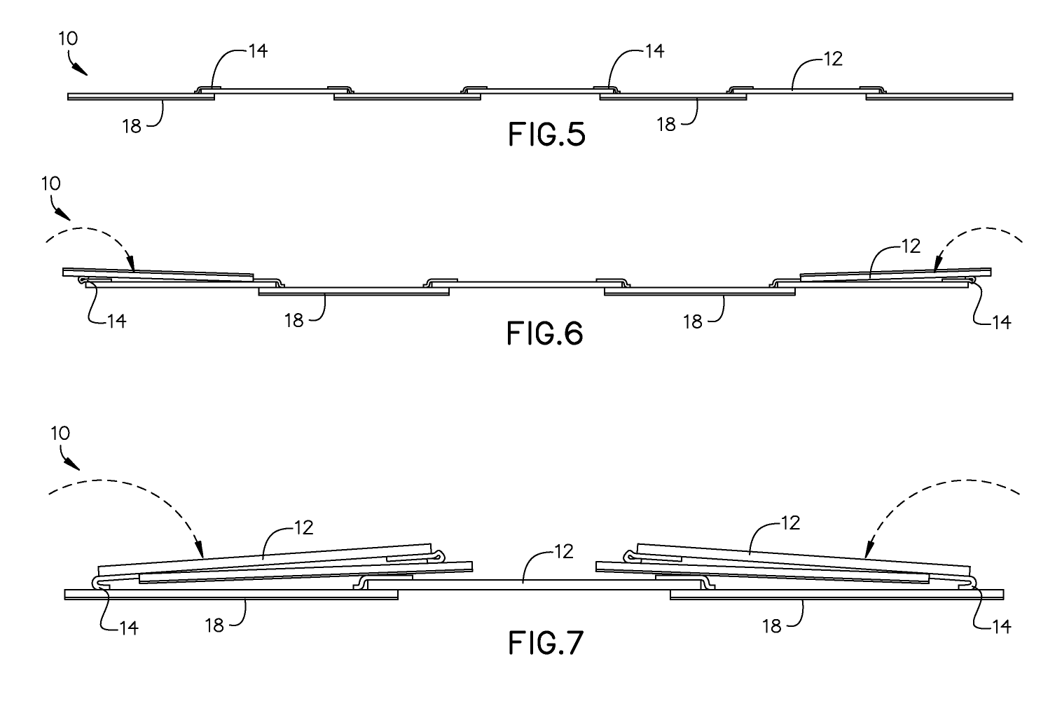

By way of example, and referring to FIGS. 1-7, some embodiments of the debris shield of the present disclosure comprise a plurality of panels 12, each panel 12 attached to an adjacent panel 12, creating a row of panels 12, wherein the row has a distal end and a proximal end. As shown in FIGS. 1, 2, and 4-7 each panel 12 may be attached to its adjacent panel(s) by a connection device, such as a line hinge 14. Attached to the panel 12 located at the distal end of the row and attached to the panel 12 located at the proximal end of the row may be a mirror fastener 16 configured to engage with a side mirror on a vehicle. For example, the mirror fastener 16 may comprise a loop configured to encircle a side mirror, as shown in FIGS. 1 and 2.

As shown in FIGS. 5-7 the debris shield 10 may be collapsible and expandable, which may be helpful for storing the debris shield 10 when not in use. For example, the debris shield 10 may be capable of collapsing in an accordion-type fashion. Alternatively, as shown in FIGS. 5-7, the debris shield 10 may collapse by folding the row of panels 12 at each hinge 14.

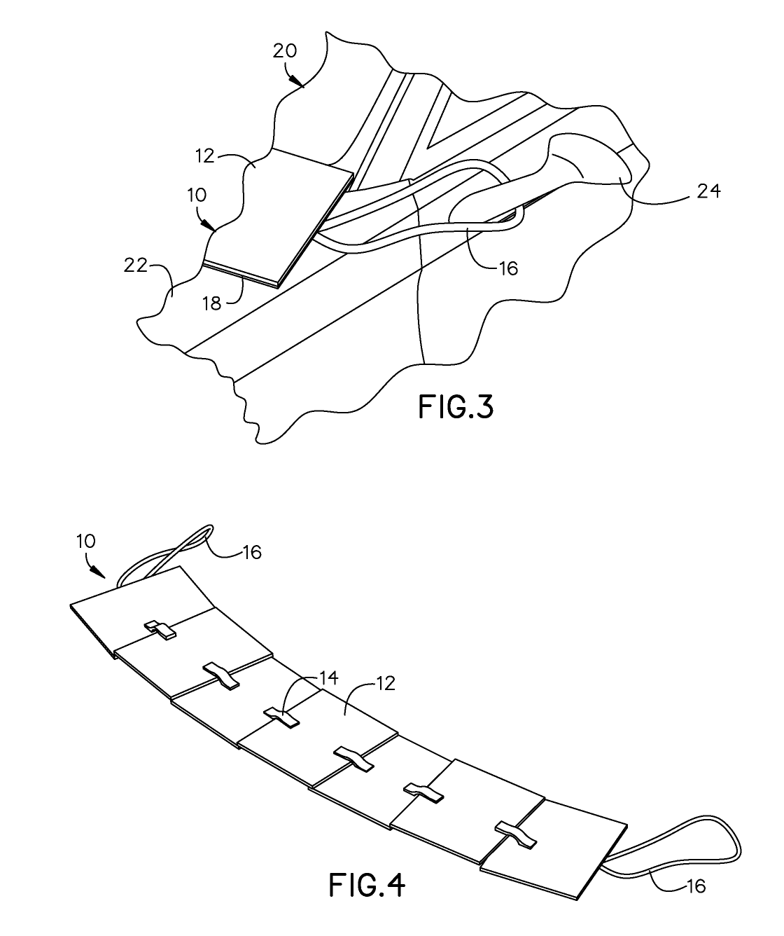

In some embodiments of the debris shield 10, the panels 12 may have a bottom surface 18 that is magnetic. For example, the entire bottom surface 18 of the panels 12 may be magnetic. Alternatively, a magnetic strip may be adhered to the bottom surface 18 of the panels 12. As a result, the debris shield 10 may be configured to removably and magnetically engage with, or attach to, a hood of a vehicle, as shown in FIG. 3.

In embodiments, and as shown in FIGS. 1 and 3, the debris shield 10 may be configured to cover the area, also known as a cowl, of a vehicle 20 between the bottom of the windshield and the beginning of the hood 22. Some embodiments of the debris shield 10 have a length and width just larger than the cowl area. However, alternate embodiments may be large enough to cover both the cowl area and the windshield of a vehicle 20. As such, the debris shield 10 may prevent debris from entering into the engine compartment of a vehicle through this cowl area and, in some embodiments, may also prevent debris or other materials, such as ice, from coating the windshield. The debris shield 10 may be secured in place over the cowl area and, if applicable, the windshield by both the magnetic bottom 18 and the mirror fasteners 16.

In embodiments, the debris shield 10 comprises a plurality of panels 12, such that the debris shield 10 is approximately the same size as, or slightly larger than, the width of a vehicle 20. For example, some embodiments of the debris shield 10 may comprise about 5 to about 10 panels; however, more panels may be present for larger vehicles and fewer panels may be needed for smaller vehicles. Some embodiments of the debris shield 10 may have a length of about 56 inches and a height of about 8 inches.

The debris shield may be made of any suitable material and, in some embodiments, is made from a waterproof, water resistant, or water repellant cloth material secured around a guide-wire frame, which may help the shield and panels keep their shape. Alternatively, the debris shield may be made of any other material, such as a durable, lightweight plastic material.

A user may attach the debris shield 10 to a vehicle 20, such as a car or a truck, by expanding the debris shield 10 to cover the width of the vehicle 20, placing the debris shield 10 on the cowl area of the vehicle 20, and attaching the mirror fasteners 16 to the side mirrors 24. In some embodiments, a user may also position the magnetic bottom surface 18 of the panels 12 to overlap with the edge of the hood 22, which may help keep the debris shield 10 in place. When a user wishes to use the vehicle, the user may simply remove the debris shield (and any collected debris, such as leaves), collapse the debris shield, and store the debris shield until the next time that it will be used.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A debris shield for preventing debris from entering an engine compartment of a vehicle, the debris shield comprising:
a plurality of panels connected together forming a row of panels, the row having a proximal end and a distal end; and
a first mirror fastener attached to the proximal end of the row and a second mirror fastener attached to the distal end of the row, wherein:
the mirror fasteners are each configured to engage with a side mirror on a vehicle; and
the row of panels is collapsible.

2. The debris shield of claim 1, further comprising a magnetic strip attached to a bottom surface of the row of panels, such that the row of panels is configured to removably attach to a hood of the vehicle.

3. The debris shield of claim 1, wherein:
each of the panels comprises a bottom surface that is configured to be positioned against the vehicle; and
the bottom surface of each of the panels is magnetic, such that each of the panels is configured to removably attach to a hood of the vehicle.

4. The debris shield of claim 1, wherein the debris shield has a size suitable to cover a cowl area of the vehicle.

5. The debris shield of claim 4, wherein the debris shield has a length of about 56 inches and a height of about 8 inches.

6. The debris shield of claim 1, wherein the debris shield comprises about 5 to about 10 panels.

7. The debris shield of claim 1, wherein each panel is connected to an adjacent panel by a hinge.

8. The debris shield of claim 7, wherein the debris shield is configured to collapse by folding the row of panels at each hinge.

9. A debris shield for preventing debris from entering an engine compartment of a vehicle, the debris shield comprising:
a row comprising a plurality of panels, each panel being attached to an adjacent panel by a hinge, the row being collapsible and expandable, wherein the row has a proximal end, a distal end, and a bottom surface, the bottom surface configured to removably engage with a hood of the vehicle;
a first loop attached to the proximal end of the row; and
a second loop attached to the distal end of the row,
wherein the first loop and the second loop are configured to attach to side mirrors on the vehicle, securing the debris shield in place.

10. The debris shield of claim 9, wherein the row is configured to collapse and expand in an accordion-type way.
